(19) United States
(12) Patent Application Publication
(10) Pub. No.: US 2026/0303429 A1
(43) Pub. Date: Oct. 1, 2026

(54) PHASE SHIFT INDICATION IN EACH SUBBLOCK OF A PARTIAL TRANSMIT SEQUENCE BASED-TRANSMISSION

(71) Applicant: QUALCOMM Incorporated, San Diego, CA (US)

(72) Inventors: Juan Carlos BUCHELI GARCIA, Marseille (FR); Lianghai JI, San Diego, CA (US); Mehmet Izzet GURELLI, San Diego, CA (US); Weimin DUAN, San Diego, CA (US); Karthik ANANTHA SWAMY, La Jolla, CA (US); Qiang WU, San Diego, CA (US)

(21) Appl. No.: 19/095,998

(22) Filed: Mar. 31, 2025

(51) Int. Cl. H04L 27/26

(52) U.S. Cl. CPC H04L 27/2621

(57) ABSTRACT

Various aspects of the present disclosure generally relate to wireless communication. In some aspects, a transmitter may generate a transmission that carries one or more symbols of information based at least in part on a partial transmit sequence (PTS) process, each symbol of the one or more symbols being partitioned into multiple subblocks of resources, each subblock of resources including at least one resource that is designated for an indication of a respective phase shift for the subblock, the respective phase shift based at least in part on the PTS process. The transmitter may transmit the transmission such that, for each subblock of the multiple subblocks, a respective portion of the transmission that occupies the subblock of resources includes the respective phase shift, the indication of the respective phase shift being carried in the respective portion of the transmission that includes the phase shift. Numerous other aspects are described.

### FIELD OF THE DISCLOSURE

Aspects of the present disclosure generally relate to wireless communication and specifically relate to techniques, apparatuses, and methods associated with a phase shift indication in each subblock of a partial transmit sequence-based transmission.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Some wireless communication systems use an orthogonal frequency division multiplexing (OFDM) modulation technique to increase data throughput and mitigate interference. As an example, a transmitter may use OFDM to transmit user data by transmitting a portion of the user data on a respective sub-carrier of multiple orthogonal sub-carriers. The transmitter may make each sub-carrier orthogonal by spacing the sub-carriers at intervals that are equal to an inverse of a symbol duration such that the peak of a first sub-carrier coincides with the nulls of adjacent sub-carriers.

### SUMMARY

The systems, methods, and devices of this disclosure each have several innovative aspects, no single one of which is solely responsible for the desirable attributes disclosed herein.

Some aspects described herein relate to a method of wireless communication performed by a receiver. The method may include receiving a transmission that carries one or more symbols of information, each symbol of the one or more symbols being partitioned into multiple subblocks of resources based at least in part on a partial transmit sequence (PTS) process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process. The method may include decoding the one or more symbols of information based at least in part on compensating, for each subblock of the multiple subblocks, for the respective phase shift that is associated with the subblock of resources.

Some aspects described herein relate to a method of wireless communication performed by a transmitter. The method may include generating a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process. The method may include transmitting the transmission such that, for each subblock of the multiple subblocks, a respective portion of the transmission that occupies the subblock of resources includes the respective phase shift, the indication of the respective phase shift being carried in the respective portion of the transmission that includes the phase shift.

Some aspects described herein relate to a non-transitory computer-readable medium that stores a set of instructions for wireless communication by a receiver. The set of instructions, when executed by one or more processors of the receiver, may cause the receiver to receive a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process. The set of instructions, when executed by one or more processors of the receiver, may cause the receiver to decode the one or more symbols of information based at least in part on compensating, for each subblock of the multiple subblocks, for the respective phase shift that is associated with the subblock of resources.

Some aspects described herein relate to a non-transitory computer-readable medium that stores a set of instructions for wireless communication by a transmitter. The set of instructions, when executed by one or more processors of the transmitter, may cause the transmitter to generate a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process. The set of instructions, when executed by one or more processors of the transmitter, may cause the transmitter to transmit the transmission such that, for each subblock of the multiple subblocks, a respective portion of the transmission that occupies the subblock of resources includes the respective phase shift, the indication of the respective phase shift being carried in the respective portion of the transmission that includes the phase shift.

Some aspects described herein relate to an apparatus for wireless communication. The apparatus may include means for receiving a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process. The apparatus may include means for decoding the one or more symbols of information based at least in part on compensating, for each subblock of the multiple subblocks, for the respective phase shift that is associated with the subblock of resources.

Some aspects described herein relate to an apparatus for wireless communication. The apparatus may include means for generating a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process. The apparatus may include means for transmitting the transmission such that, for each subblock of the multiple subblocks, a respective portion of the transmission that occupies the subblock of resources includes the respective phase shift, the indication of the respective phase shift being carried in the respective portion of the transmission that includes the phase shift.

Some aspects described herein relate to a receiver. The receiver may include a processing system. The processing system may include one or more processors and one or more code-storing memories coupled with the one or more processors. The processing system may be configured to cause the receiver to receive a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process. The processing system may be configured to cause the receiver to decode the one or more symbols of information based at least in part on compensating, for each subblock of the multiple subblocks, for the respective phase shift that is associated with the subblock of resources.

Some aspects described herein relate to a transmitter. The transmitter may include a processing system. The processing system may include one or more processors and one or more code-storing memories coupled with the one or more processors. The processing system may be configured to cause the transmitter to generate a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process. The processing system may be configured to cause the transmitter to transmit the transmission such that, for each subblock of the multiple subblocks, a respective portion of the transmission that occupies the subblock of resources includes the respective phase shift, the indication of the respective phase shift being carried in the respective portion of the transmission that includes the phase shift.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of a partial transmit sequence process at a transmitter.

FIG. 4 is a diagram illustrating an example of a subblock resource that is designated to carry an indication of a phase shift.

FIG. 5 is a diagram illustrating an example of amplitude modulation as applied to a segment of a transmission that carries an indication of a phase shift.

FIG. 6 is a diagram illustrating an example of a wireless communication process between a transmitter and a receiver.

FIG. 7 is a diagram illustrating an example process performed, for example, at a receiver or an apparatus of a receiver.

FIG. 8 is a diagram illustrating an example process performed, for example, at a transmitter or an apparatus of a transmitter.

FIG. 9 is a diagram of an example apparatus for wireless communication.

FIG. 10 is a diagram of an example apparatus for wireless communication.

### DETAILED DESCRIPTION

Some wireless communication systems use an orthogonal frequency division multiplexing (OFDM) modulation technique to increase data throughput and mitigate interference. As an example, a transmitter may use OFDM to transmit user data by transmitting a respective portion of the user data on a respective sub-carrier of multiple orthogonal sub-carriers. The transmitter may make each sub-carrier orthogonal by spacing the sub-carriers at intervals that are equal to an inverse of a symbol duration such that the peak of a first sub-carrier coincides with the nulls of adjacent sub-carriers. This spacing mitigates interference between sub-carriers, resulting in increased data throughput for the available bandwidth. OFDM may also provide robustness against multipath interference by converting a high-speed data stream into multiple lower-speed streams that are transmitted simultaneously using the multiple sub-carriers, which may mitigate signal fading and delay spread by ensuring that each sub-carrier experiences a flat fading channel, making it easier to equalize and recover the transmitted data. In some cases, a transmitter may dynamically allocate sub-carriers to an OFDM-based transmission based at least in part on current channel conditions, thus enabling the transmitter to increase the performance of the OFDM-based transmission (e.g., increased data throughput or reduced interference) by adapting to varying channel environments.

A transmitter using OFDM may include a power amplifier (PA) in the transmission chain to boost a transmit power level to mitigate signal degradation in transmissions that propagate over long distances or through challenging environments. An example of a channeling environment is an environment with a high path-loss, such as a transmission in a non-terrestrial network (NTN) that propagates through space. To illustrate, a first transmission in an NTN may travel a further distance relative to a second transmission in a terrestrial network (TN), and may propagate through space or other mediums with a higher path-loss relative to the second transmission. Accordingly, the use of a PA may increase the reliability of transmissions (e.g., in an NTN or a TN) by compensating for path-loss.

Several factors may reduce an efficiency of a PA, leading to increased power consumption by the PA. As one example, the multiple sub-carriers of an OFDM transmission may constructively interfere and may create high peak power levels that result in an input signal at the PA with a high peak-to-average power ratio (PAPR). The high PAPR of OFDM signals may result in out-of-band emissions due to the non-linearities of a PA, and may cause interference in adjacent channels that degrade overall system performance. For example, in an NTN, the out-of-band emissions may result in interference over large coverage areas that reduces data throughput, increase data transfer latencies, or increase data recovery errors. To avoid nonlinearities and signal distortion in an output signal, the PA may operate with a back-off value (e.g., 6 decibels (dB) to 10 dB from a maximum power of the PA) that reduces a power level at the PA to ensure that the PA operates within a lower power region that maintains linear signal processing. However, operating in the lower power region may result in the PA consuming more power relative to operating in a higher power region.

Some communication standards for NTNs may prioritize efficient power utilization due to the high costs associated with power generation and dissipation in space, such as the expense of developing and maintaining efficient batteries, and the challenges of heat dissipation in the vacuum of space. Alternatively, or additionally, a communication standard may specify strict operating conditions to mitigate out-of-band emissions and interference with adjacent channels. In uplink scenarios, the combination of battery operation and high path-loss constraints may lead to a user equipment (UE) operating a PA close to saturation for maximum efficiency, potentially leading to battery drain in the UE and a reduced battery life at the UE.

A wireless communication system may use a partial transmit sequence (PTS) for OFDM transmissions, in order to reduce PAPR. For example, a transmitter may divide an OFDM signal into multiple subblocks or multiple signal portions (e.g., multiple portions of the OFDM signal) and may apply a respective phase shift to each signal portion independently. The transmitter may then combine the multiple phase-shifted signal portions to form a final transmission signal. Applying phase shifts to multiple signal portions and combining the phase-shifted signal portions may reduce peak amplitudes of the resultant final transmission signal and, consequently, reduce PAPR of the final transmission signal, leading to more efficient PA operation.

A receiver may recover information from a PTS-based signal by using phase shift information to compensate for the added phase shifts. As one example, the transmitter may transmit phase shift information (e.g., quantized phase shift information) using a separate transmission or transmission channel than the PTS-modified transmission (e.g., that carries user data). However, the use of a separate transmission or transmission channel may increase signaling overhead, resulting in reduced data throughput and increased data transfer latencies. Alternatively, or additionally, the transmission of phase shift information in the separate transmission may increase a complexity in the transmitter-receiver system based at least in part on the receiver needing synchronization and coordination between the data and phase shift information channels, resulting in increased processing complexity and increased potential for errors in phase information recovery.

Various aspects relate generally to a phase shift indication in each subblock of a PTS-based transmission. Some aspects more specifically relate to embedding the phase shift indication in the phase-shifted transmission. In some aspects, a transmitter may generate a transmission that carries one or more symbols of information. The transmitter may generate the transmission based at least in part on a PTS process. As at least part of the PTS process, the transmitter may partition each symbol into multiple subblocks of resources, and designate at least one resource within each subblock for an indication of a respective phase shift based on the PTS process. To illustrate, each resource in a subblock may be one or more air interface resources (e.g., one or more time-frequency elements) that are allocated to carry at least a respective portion of the transmission (e.g., a modulated symbol) and the indication of the respective phase shift that is applied to the portion of the transmission. That is, each subblock of resources may be assigned to carry a respective portion of the transmission that includes a respective phase shift applied as at least part of the PTS process, and the indication of the respective phase shift may be carried in the respective portion of the transmission that includes the phase shift. The indications of the respective phase shifts may enable a receiver to decode the symbol(s) of information carried in the transmission by enabling the receiver to compensate for the respective phase shift applied to each respective portion of the transmission.

Particular aspects of the subject matter described in this disclosure can be implemented to realize one or more of the following potential advantages. In some examples, by embedding a respective indication of a phase shift in each respective phase-shifted transmission, the described techniques can be used to enable a receiver to compensate for the respective phase shift applied to each respective portion of the transmission, such as by removing the respective phase shift, and recover the transmitted information successfully (e.g., without decoding errors). Embedding the indication of a phase shift in a phase-shifted transmission may also reduce signaling overhead that is associated with using a separate, parallel channel and transmission to carry the phase information, resulting in increased data throughput and decreased data transfer latencies. Alternatively, or additionally, embedding the indication of a phase shift in a phase-shifted transmission may also reduce a PAPR of a transmitted signal, leading to more PA operation that mitigates battery drain and extends battery life in a UE and enables the UE to compensate for high path-loss in a manner that complies with operating conditions of a communication standard to reduce out-of-band emissions and interference with adjacent channels, such as a high path-loss and out-of-band emissions associated with an NTN. Embedding the phase shift information in the same phase-shifted transmission may also mitigate the complexity of synchronization and coordination used to process separate channels, resulting in a simplified transmitter-receiver system, reduced processing, and a reduced potential of errors in phase information recovery.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, NTN deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

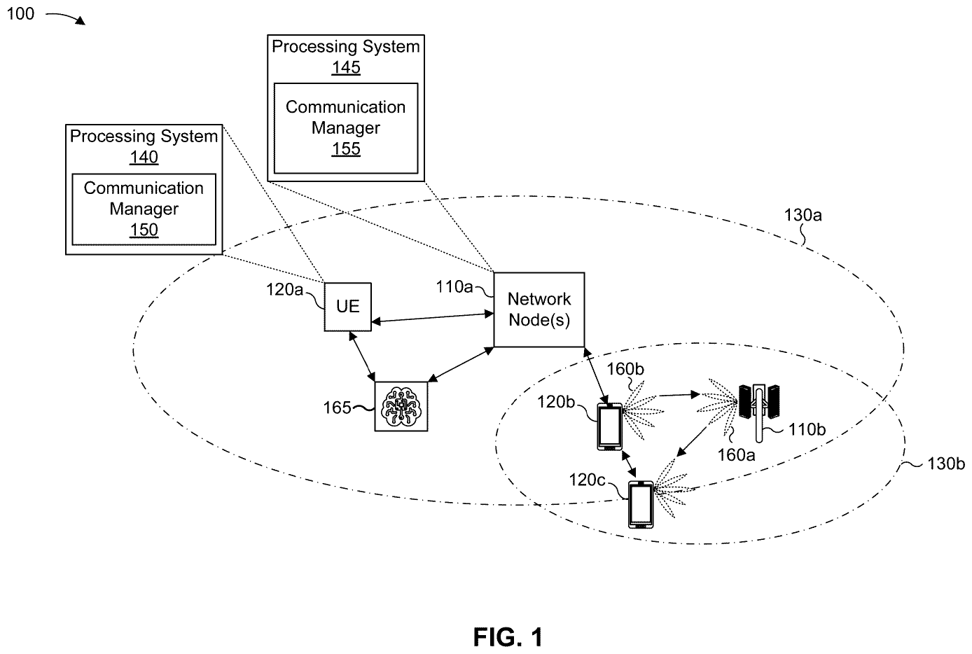

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR 4(52.6 GHz through 114.25 GHz), and FR5 (114.25 GHz through 300 GHz). Although a portion of FR 1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a contiguous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-OFDM (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., a UE 120) may include a communication manager 150. As described in more detail elsewhere herein, based at least in part on the UE being a receiver, the communication manager 150 may receive a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process; and decode the one or more symbols of information based at least in part on compensating, for each subblock of the multiple subblocks, for the respective phase shift that is associated with the subblock of resources.

Alternatively, or additionally, the UE may be a transmitter, and the communication manager 150 may generate a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process; and transmit the transmission such that, for each subblock of the multiple subblocks, a respective portion of the transmission that occupies the subblock of resources includes the respective phase shift, the indication of the respective phase shift being carried in the respective portion of the transmission that includes the phase shift. Additionally, or alternatively, the communication manager 150 may perform one or more other operations described herein.

In some aspects, a network node (e.g., a network node 110) may include a communication manager 155. As described in more detail elsewhere herein, based at least in part on the network node being a receiver, the communication manager 155 may receive a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process; and decode the one or more symbols of information based at least in part on compensating, for each subblock of the multiple subblocks, for the respective phase shift that is associated with the subblock of resources.

Alternatively, or additionally, the network node may be a transmitter, and the communication manager 155 may generate a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process; and transmit the transmission such that, for each subblock of the multiple subblocks, a respective portion of the transmission that occupies the subblock of resources includes the respective phase shift, the indication of the respective phase shift being carried in the respective portion of the transmission that includes the phase shift. Additionally, or alternatively, the communication manager 155 may perform one or more other operations described herein.

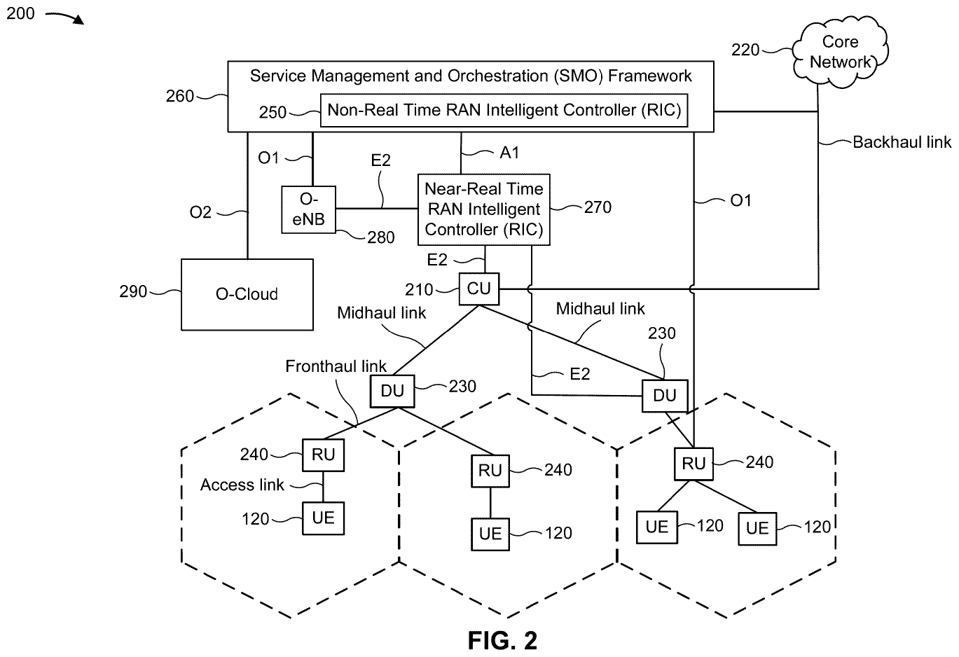

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

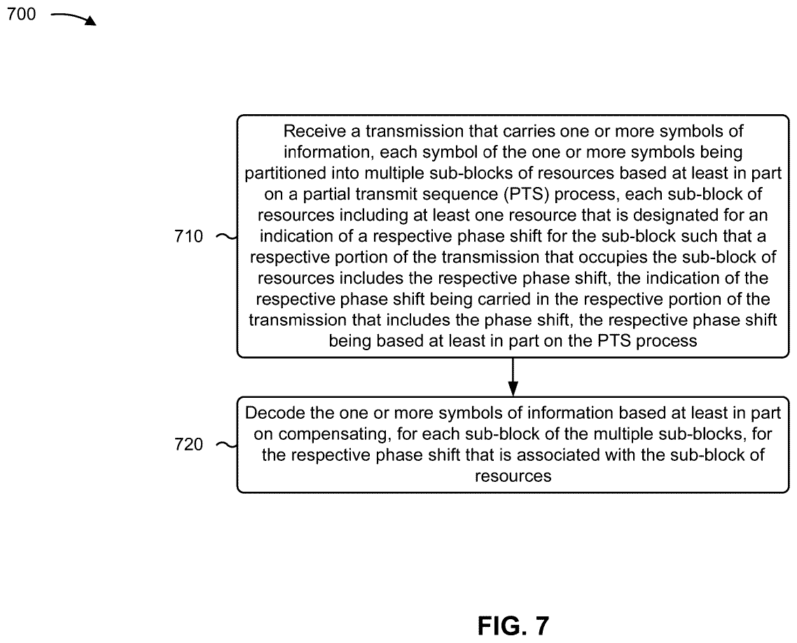

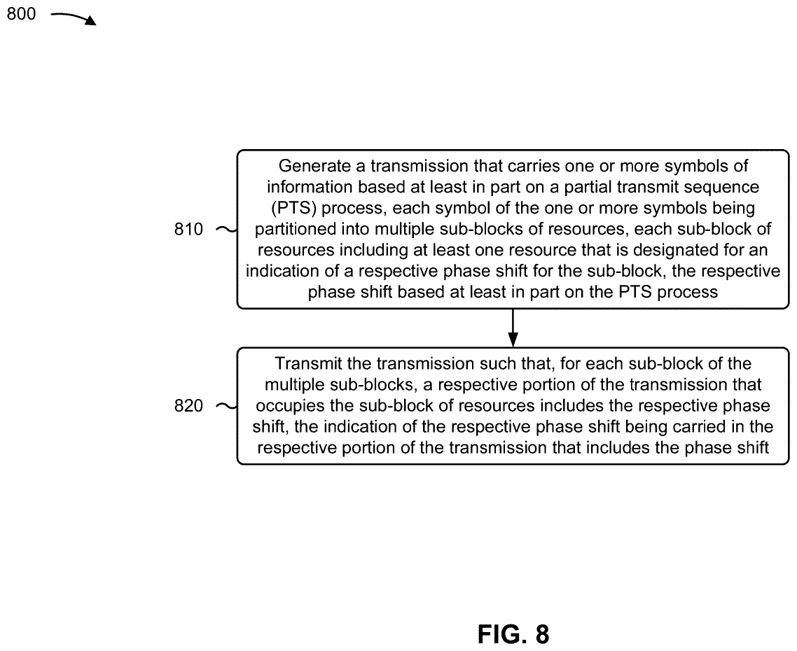

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies). The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with a phase shift indication in each subblock of a PTS-based transmission, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). In some aspects, the transmitter described herein is the network node 110, is included in the network node 110, or includes one or more components of the network node 110 shown in FIG. 1. Alternatively, or additionally, the receiver described herein is the network node 110, is included in the network node 110, or includes one or more components of the network node 110 shown in FIG. 1. In some aspects, the transmitter described herein is the UE 120, is included in the UE 120, or includes one or more components of the UE 120 shown in FIG. 1. Alternatively, or additionally, the receiver described herein is the UE 120, is included in the UE 120, or includes one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

In some aspects, a UE (e.g., a UE 120) may be a receiver and include means for receiving a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process; or means for decoding the one or more symbols of information based at least in part on compensating, for each subblock of the multiple subblocks, for the respective phase shift that is associated with the subblock of resources.

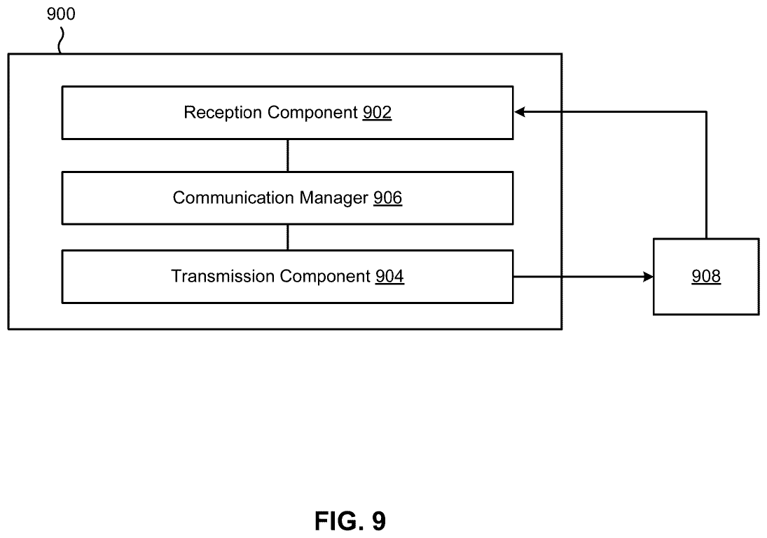

Alternatively, or additionally, the UE is a transmitter and includes means for generating a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process; or means for transmitting the transmission such that, for each subblock of the multiple subblocks, a respective portion of the transmission that occupies the subblock of resources includes the respective phase shift, the indication of the respective phase shift being carried in the respective portion of the transmission that includes the phase shift. In some aspects, the means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

In some aspects, a network node (e.g., a network node 110) may be a receiver and include means for receiving a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process; or means for decoding the one or more symbols of information based at least in part on compensating, for each subblock of the multiple subblocks, for the respective phase shift that is associated with the subblock of resources.

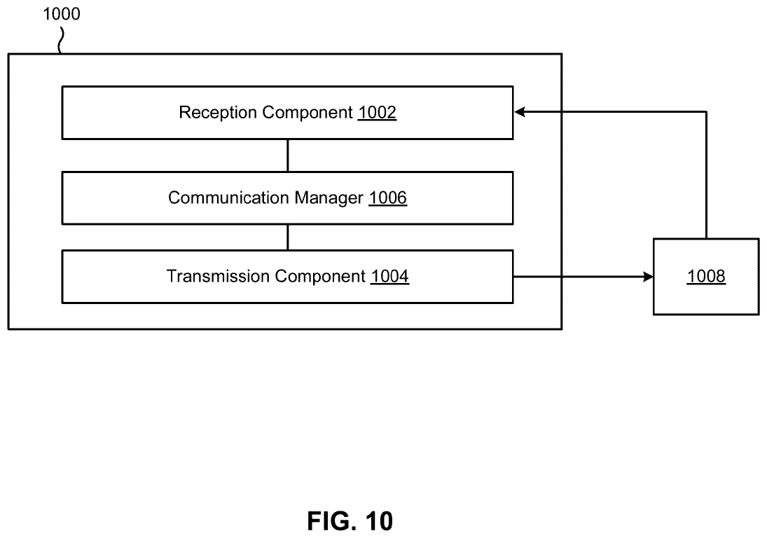

Alternatively, or additionally, the network node is a transmitter and includes means for generating a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process; or means for transmitting the transmission such that, for each subblock of the multiple subblocks, a respective portion of the transmission that occupies the subblock of resources includes the respective phase shift, the indication of the respective phase shift being carried in the respective portion of the transmission that includes the phase shift. In some aspects, the means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

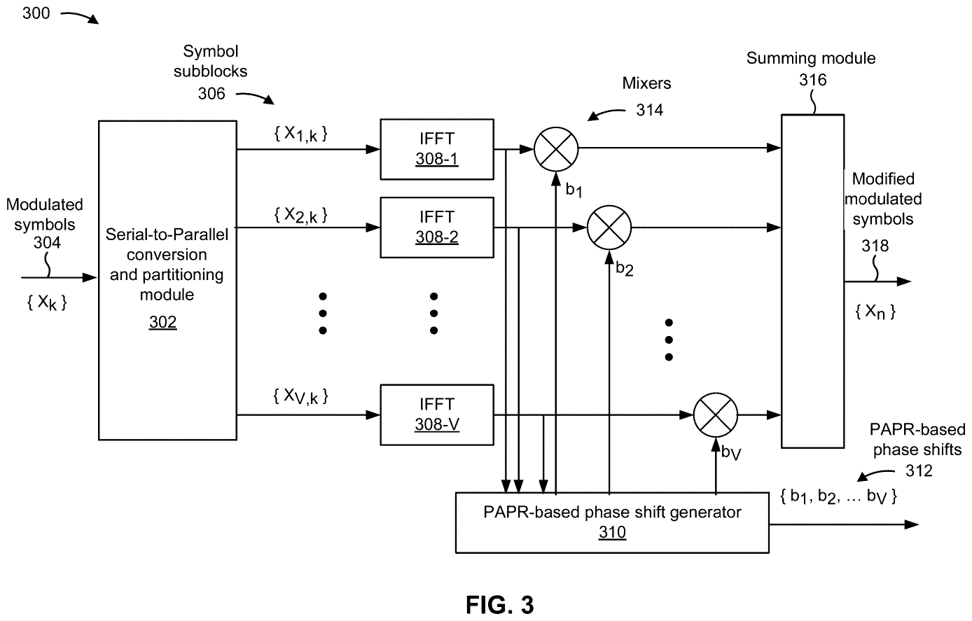

FIG. 3 is a diagram illustrating an example 300 of a PTS process at a transmitter.

A transmitter using OFDM may include a PA in the transmission chain to boost a transmit power level to mitigate signal degradation in transmissions that propagate over long distances or through challenging environments. An example of a channeling environment is an environment with a high path-loss, such as a transmission in an NTN that propagates through space. For instance, a first transmission in an NTN may travel a further distance relative to a second transmission in a TN, and may propagate through a medium with a higher path-loss relative to the second transmission. Accordingly, the use of a PA may increase the reliability of transmissions by compensating for an expected path-loss.

Several factors may reduce an efficiency of a PA, leading to increased power consumption by the PA. As one example, the multiple sub-carriers of an OFDM transmission may constructively interfere and create high peak power levels that result in an input signal at the PA with a high PAPR. In some cases, the high PAPR of OFDM signals may result in out-of-band emissions due to the non-linearities of a PA, and may cause interference in adjacent channels that degrade overall system performance. For example, in an NTN, the out-of-band emissions may result in interference over large coverage areas that reduces data throughput, increase data transfer latencies, or increase data recovery errors. To avoid nonlinearities and signal distortion in an output signal, the PA may operate with a back-off value (e.g., 6 dB to 10 dB from a maximum power of the PA) that reduces a power level at the PA to ensure that the PA operates within a lower power region that maintains linear signal processing. However, operating in the lower power region may result in the PA consuming more power relative to operating in a higher power region.

Some communication standards for NTNs may prioritize efficient power utilization due to the high costs associated with power generation and dissipation in space, such as the expense of developing and maintaining efficient batteries, and the challenges of heat dissipation in the vacuum of space. Alternatively, or additionally, a communication standard may specify strict operating conditions to mitigate out-of-band emissions and interference with adjacent channels. In uplink scenarios, the combination of battery operation and high path-loss constraints may lead to a UE operating a PA close to saturation for maximum efficiency, potentially leading to battery drain in the UE and a reduced battery life at the UE.

To mitigate PAPR and reduce power consumption at a UE, a wireless communication system may use PTS for OFDM transmissions to reduce PAPR. For example, a transmitter may divide an OFDM signal into multiple subblocks or multiple signal portions (e.g., multiple portions of the OFDM signal) and may apply a respective phase shift to each signal portion independently. The transmitter may then combine the multiple phase-shifted signal portions to form a final transmission signal. Applying phase shifts to multiple signal portions and combining the phase-shifted signal portions may reduce peak amplitudes of the resultant final transmission signal and, consequently, reduce PAPR of the final transmission signal, leading to more efficient PA operation.

To illustrate, FIG. 3 includes a block diagram of a portion of a transmission chain that performs PTS. As shown by FIG. 3, the transmitter may include a serial-to-parallel conversion and partitioning module 302 that receives an input signal that includes one or more modulated symbols 304 that are generally shown by FIG. 3 as Xₖ, where X is a modulated symbol that includes k subcarriers in the modulated symbols 304. To illustrate, the serial-to-parallel conversion and partitioning module 302 may be operatively coupled to the output of an OFDM modulation module that outputs the modulated symbols 304 based at least in part on dividing a high-speed data stream into multiple lower-speed data streams and modulating each lower-speed data stream as respective symbols on different orthogonal sub-carriers (e.g., k orthogonal sub-carriers). The OFDM modulator may then combine the modulated sub-carriers into a single composite signal that includes multiple orthogonal sub-carriers, with each orthogonal sub-carrier carrying a respective portion of the original data stream.

The serial-to-parallel converter and partitioning module 302 may convert the modulated symbols 304 from a serial data stream to parallel data streams. As at least part of converting the modulated symbols 304 to parallel data streams, the serial-to-parallel conversion and partitioning module 302 may divide the modulated symbols 304 into one or more symbol subblocks 306. As one example, the serial-to-parallel converter and partitioning module 302 may receive the modulated symbols 304 as a frequency domain. The serial-to-parallel converter and partitioning module 302 may partition a frequency-domain representation of the modulated symbols 304 into the symbol subblocks 306 based at least in part on subcarriers or groups of subcarriers. As shown by FIG. 3, the serial-to-parallel converter and partitioning module 302 may partition the modulated symbols 304 into V symbol subblocks that are shown as X_{1,k}, X_{2,k}, up to X_{V,k}. Each subblock may include a single symbol in the modulated symbols 304, multiple symbols in the modulated symbols 304, a single subcarrier, multiple subcarriers, or any combination thereof. A partitioning scheme used by the serial-to-parallel converter and partitioning module 302 to generate the subblocks 306, and the respective portion of the input signal (e.g., the modulated symbols 304) included in each respective subblock may be based on predefined criteria (e.g., fixed subcarrier grouping or fixed symbol-based partitioning), current operating conditions (e.g., channel quality, a UE battery level, or a UE speed), or a combination of the two, that result in dynamic adjustments to the partitioning scheme, such as adaptive sub-carrier grouping based on an interference level or adaptive partitioning based on a UE battery level to reduce power consumption (e.g., fewer symbol subblocks). Each symbol subblock of the symbol subblocks 306 may include a respective segment of the original modulated symbols 304, and the respective segment may include one or more symbols.

As at least part of the PTS process, each subblock of the symbol subblocks 306 may be transformed from the frequency domain to the time domain, shown by FIG. 3 as a first inverse Fast Fourier transform (IFFT) module 308-1, a second IFFT module 308-2, up to a V-th IFFT module 308-V. As an example, each IFFT module may process each symbol subblock using signal processing (e.g., digital signal processing) configured to perform an IFFT. Each transformed signal subblock may be fed as input to a PAPR-based phase shift generator 310 that computes one or more PAPR-based phase shifts 312, shown as b₁, b₂, . . . b_{V}. That is, the PAPR-based phase shift generator 310 may generate a respective phase shift for each symbol subblock such that V input symbol subblocks may result in V phase shift outputs. As one example, the PAPR-based phase shift generator 310 may compute the phase shifts using the combination of the symbol subblocks and minimizing techniques (e.g., an exhaustive search, iterative clipping and peak reduction, or a randomized search) that minimize the PAPR of a composite transmission. In some aspects, the minimizing techniques may result in the PAPR-based phase shift generator 310 including alternate or additional modules relative to the example shown by FIG. 3, such as a clipping module (e.g., a hardware clipping module or a digital signal processing block that simulates hardware clipping). Alternatively, or additionally, the PAPR-based phase shift generator 310 may evaluate various combinations of potential phase shifts to apply to the subblocks, and may select a combination of phase shifts that results in the lowest PAPR, such as by evaluating an initial set of phase shifts and iteratively adjusting each phase shift to reduce the PAPR. This process may continue until a predefined convergence criterion is met or a maximum number of iterations is reached. In some aspects, the PAPR-based phase shift generator 310 may select quantized phase shifts from a predefined set of discrete values based at least in part on the computed phase shifts. In other aspects, the PAPR-based phase shift generator 310 may select continuous phase shifts.

As shown by FIG. 3, the transmitter may apply each respective phase shift to the respective symbol subblock (e.g., the respective portion of the transmission that carries the respective symbol subblock). In some aspects, the transmitter may apply the respective phase shifts using one or more mixers 314, but other examples may use other modulation techniques that apply phase shifts to the subblock outputs, such as QAM mixers. The phase-shifted symbol subblocks (e.g. the phase-shifted portions of the transmission) may be fed into a summing module 316 that combines the phase-shifted symbol subblocks to generate an output signal, shown by FIG. 3 as modified modulated symbols 318. That is, the summing module 316 may aggregate the phase-shifted symbol subblocks into a single output signal for transmission, and the aggregated output signal may have reduced PAPR relative to the input signal (e.g., modulated symbols 304) based at least in part on the PTS process.

In some cases, as shown by FIG. 3, the transmitter may also generate and transmit a separate transmission that carries phase shift information (e.g., b₁, b₂, . . . b_{V}) to enable a receiver to recover information from a PTS-based signal. For example, the receiver may use the phase shift information to compensate for the added phase shifts. However, transmission of phase shift information in a separate transmission or transmission channel than the PTS-modified transmission (e.g., that carries user data) channel may increase signaling overhead, resulting in reduced data throughput and increased data transfer latencies. Alternatively, or additionally, the transmission of phase shift information in the separate transmission may increase a complexity in the transmitter-receiver system based at least in part on the receiver needing synchronization and coordination between the data and phase shift information channels, resulting in increased processing complexity and increased potential for errors in phase information recovery.

Various aspects relate generally to a phase shift indication in each subblock of a PTS-based transmission. Some aspects more specifically relate to embedding the phase shift indication in the phase-shifted transmission. In some aspects, a transmitter may generate a transmission that carries one or more symbols of information. The transmitter may generate the transmission based at least in part on a PTS process. As at least part of the PTS process, the transmitter may partition each symbol into multiple subblocks of resources, and designate at least one resource within each subblock for an indication of a respective phase shift based on the PTS process. To illustrate, each resource in a subblock may be one or more air interface resources (e.g., one or more time-frequency elements) that are allocated to carry at least a respective portion of the transmission (e.g., a modulated symbol) and the indication of the respective phase shift that is applied to the portion of the transmission. That is, each subblock of resources may be assigned to carry a respective portion of the transmission that includes a respective phase shift applied as at least part of the PTS process, and the indication of the respective phase shift may be carried in the respective portion of the transmission that includes the phase shift. The indications of the respective phase shifts may enable a receiver to decode the symbol(s) of information carried in the transmission by enabling the receiver to compensate for the respective phase shift applied to each respective portion of the transmission.

Particular aspects of the subject matter described in this disclosure can be implemented to realize one or more of the following potential advantages. In some examples, by embedding a respective indication of a phase shift in each respective phase-shifted transmission, the described techniques can be used to enable a receiver to compensate for the respective phase shift applied to each respective portion of the transmission, such as by removing the respective phase shift, and recover the transmitted information successfully (e.g., without decoding errors). Embedding the indication of a phase shift in a phase-shifted transmission may also reduce signaling overhead that is associated with using a separate, parallel channel and transmission to carry the phase information, resulting in increased data throughput and decreased data transfer latencies. Alternatively, or additionally, embedding the indication of a phase shift in a phase-shifted transmission may also reduce a PAPR of a transmitted signal, leading to more PA operation that mitigates battery drain and extends battery life in a UE and enables the UE to compensate for high path-loss in a manner that complies with operating conditions of a communication standard to reduce out-of-band emissions and interference with adjacent channels, such as a high path-loss and out-of-band emissions associated with an NTN. Embedding the phase shift information in the same phase-shifted transmission may also mitigate the complexity of synchronization and coordination used to process separate channels, resulting in a simplified transmitter-receiver system, reduced processing, and a reduced potential of errors in phase information recovery.

As indicated above, FIG. 3 is provided as an example. Other examples may differ from what is described with regard to FIG. 3.

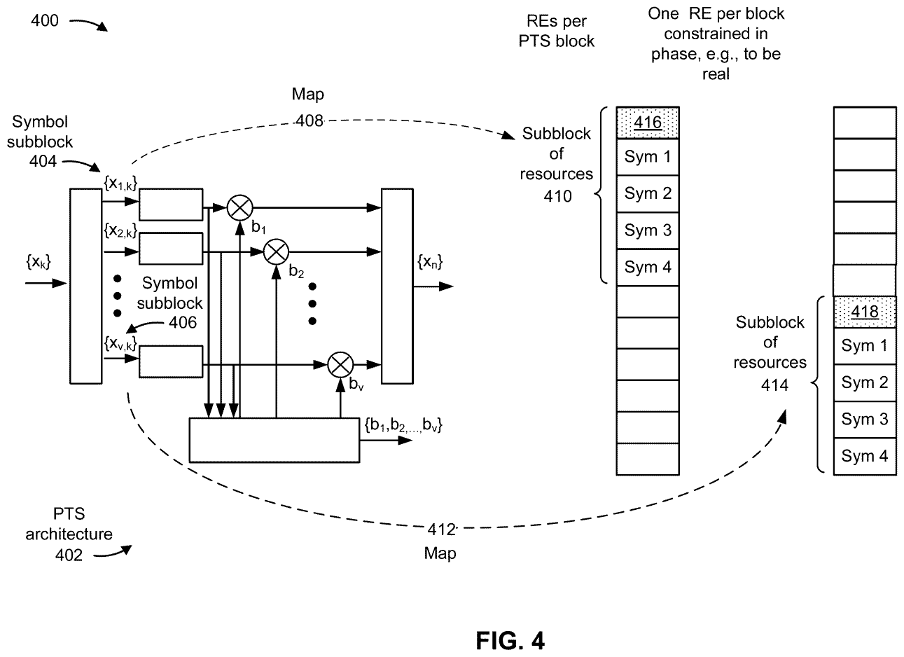

FIG. 4 is a diagram illustrating an example 400 of a subblock resource that is designated to carry an indication of a phase shift.

The example 400 shown by FIG. 4 includes an example PTS architecture 402. In some aspects, the PTS architecture 402 may include one or more modules of the PTS architecture described with regard to FIG. 3. For example, the PTS architecture 402 may include any combination of the serial-to-parallel conversion and partitioning module 302, one or more IFFT modules (e.g., IFFT module 308), the PAPR-based phase shift generator 310, one or more mixers (e.g., mixers 314), or the summing module 316. Alternatively, or additionally, the PTS architecture 402 may include an ability to embed an indication of a phase shift in designated subblock resource. That is, the PTS architecture 402 may generate multiple portions of a transmission in a similar manner as described with regard to FIG. 3, and each portion of the transmission may carry an indication of a respective phase shift that is applied to the portion of the transmission in a designated resource that is allocated to the portion of the transmission. In some aspects, the portion of the transmission that carries the indication of the phase shift is a phase-shifted transmission (e.g., shifted by the respective phase shift) such that a segment of the portion of the transmission that carries the indication of the phase shift is also phase-shifted.

To illustrate, in a similar manner as described with regard to FIG. 3, the PTS architecture 402 may partition a transmission of multiple modulated symbols into multiple subblocks, such as by partitioning the multiple modulated symbols based at least in part on one or more sub-carriers. As one example, the PTS architecture 402 may partition each symbol into multiple subblocks that are based at least in part on a fixed quantity of subcarriers or a combination of subcarriers and time slots (e.g., 12 subcarriers for one OFDM symbol duration). Alternatively, the PTS architecture 402 may be configured to use a dynamically adjustable subblock that is adjusted based at least in part on channel conditions, as described below. Accordingly, the PTS architecture 402 may generate a first symbol subblock 404 that is a first portion of the transmission and a V-th symbol subblock 406 that carries a V-th portion of the transmission. A respective phase shift may be applied to each portion of the transmission to generate respective phase-shifted transmission portions, and the PTS architecture 402 (or a transmitter that includes the PTS architecture 402) may map each phase-shifted transmission portion to respective subblocks of resources. For example, as shown by reference number 408, the PTS architecture may map the first symbol subblock 404 (or the first phase-shifted transmission portion) to a first subblock of resources 410. As shown by reference number 412, the PTS architecture 402 (or a transmitter that includes the PTS architecture 402) may map the V-th symbol subblock 406 to a V-th subblock of resources 414.

The entirety of resources for the entirety of subblocks may be contiguous or non-contiguous. To illustrate, the first subblock of resources 410 may include a first set of air interface resources that are contiguous with a second set of air interface resources in a second subblock of resources, the second set of air interface resources may be contiguous with a third set of air interface resources in a third subblock of resources, up to a V-th set of air interface resources in the V-th subblock of resources 414 being contiguous with a (V−1)-th set of air interface resources in a (V−1)-th subblock of resources. Alternatively, the air interface resources may be non-contiguous, such that the first set of air interface resources are non-contiguous with the second set of air interface resources, up to the V-th set of air interface resources being non-contiguous with the (V−1)-th set of air interface resources. In a similar manner, the air interface resources within a subblock of resources may be contiguous with one another, or non-contiguous. “Contiguous air interface resources” denotes a set of frequency resources that are adjacent to each other without any gaps (e.g., the resources are allocated in a continuous block in the frequency domain, the time domain, or both). “Non-contiguous air interface resources” denote a set of frequency or time resources that are separated by gaps (e.g., gaps in the frequency domain, the time domain, or both).

In a similar manner as described with regard to FIG. 3, the PTS architecture 402 may compute one or more phase shifts and may apply a respective phase shift to a respective symbol subblock. For example, a phase shift generator (e.g., the phase shift generator 310) may compute a respective phase shift for each symbol subblock based at least in part on minimizing a PAPR of an output transmission. The phase shift can be determined using an iterative algorithm that adjusts the phase of each subblock to reduce the overall PAPR. As an example, the phase shift generator may use the symbol subblocks as input and use minimizing techniques (e.g., an exhaustive search, iterative clipping and peak reduction, or a randomized search) that minimize the PAPR of a composite transmission. As described above, some minimizing techniques may result in additional or alternative modules within the phase shift generator, such as a clipping module (e.g., a hardware clipping module or a digital signal processing block that simulates hardware clipping).

In some aspects, each phase-shifted transmission portion may include and carry an indication of a phase shift that is applied to the phase-shifted transmission portion. The indication of the phase shift may be located in the phase-shifted transmission portion based at least in part on a designated resource in the subblock of resources that is assigned to the phase-shifted transmission portion. As one example, a resource 416 that is included in the first subblock of resources 410 may be designated to carry an indication of a phase shift that is applied to the first symbol subblock 404 (e.g., a first portion of the transmission). In a similar manner, a resource 418 that is included in the V-th subblock of resources 414 may be designated to carry an indication of a phase shift that is applied to the V-th symbol subblock 406 (e.g., a V-th portion of the transmission). For example, the resource 416 and the resource 418 may each be a first resource element (RE) of each subblock that is designated to carry the phase shift information, and the transmitter may modulate an indication of the phase shift information using a specified modulation scheme (e.g., QAM) or may apply the phase shift to each respective segment of the transmission that occupies the resource 416 and the resource 418. In at least one example, the transmitter may modulate the phase shift information indirectly by applying a respective fixed phase (e.g., that is known by the receiver) to each respective segment of the transmission portion that occupies the resource 416 and the resource 418. For such an example, the indication of the phase shift information may be embedded in the phase of the respective segment of the transmission based at least in part on a mixing stage (e.g., the mixers 314) used by the transmitter as at least part of the PTS architecture. Other symbols within the subblock of resources may use other modulation schemes that are at least phase-based (e.g., QAM) to carry information. As described herein, the other modulation schemes that are at least phase-based may be unavailable for use by the segment that carries the indication of the phase shift information. Instead, information may be carried in the segment of the transmission portion based at least in part on amplitude modulation.

As described below, additional data or information may be modulated onto the respective segment using amplitude modulation. Accordingly, a segment of each respective phase-shifted transmission portion may carry an indication of the respective phase shift that is applied to the respective phase-shifted transmission portion, and the segment may map to, or occupy, the resource 416 based at least in part on the resource 416 being designated to carry the indication of the phase shift.

The PTS architecture 402 may then generate an output signal by combining the multiple phase-shifted transmission portions, such as by using a summing module (e.g., the summing module 316), and may transmit the output signal. A receiver may demodulate the received signal, extract phase shift information from the respective designated resources, and may compensate for the respective phase shifts to recover the original data symbols. As one example, the receiver may use the extracted phase shift information to apply respective inverse phase shifts and reconstruct the transmitted symbols.

In some aspects, a designated resource within a subblock of resources may be configured by a network node. As one example, a network node may transmit an indication of a PTS configuration (e.g., a PTS configuration indication) that specifies one or more attributes of a designated resource, one or more attributes of subblocks in a PTS-based transmission, or a combination thereof, such as by transmitting the indication in a broadcast message, a multicast message, or a unicast message. Example attributes that may be indicated in the PTS configuration may include any combination of a starting location of each subblock, an ending location of each subblock, a size of each subblock, a location of a respective designated resource for phase shift information in each subblock, or a quantity of subblocks in the transmission (e.g., V subblocks). In some cases, the PTS configuration may specify designated resource information that is specific to a particular subblock of resources, general information that applies to all subblocks in a phase-shifted transmission, or a combination of the two. The indication of a respective phase shift in each designated resource of each subblock of resources in a phase-shifted transmission may enable a receiver to compensate for the applied phase shifts and recover information carried in the respective phase-shifted transmission portion. As one example, the receiver may remove the applied phase shift from the associated phase-shifted transmission portion. Embedding an indication of a phase shift in the phase-shifted transmission may enable the receiver to recover the phase shift information in a less complex manner relative to synchronizing phase information in a first transmission with phase-shifts applied to a second transmission. In some aspects, a network node may transmit a PTS configuration indication in DCI, but in other aspects, the network node may transmit the PTS configuration information via higher layer signaling such as a MAC-CE or RRC signaling, or any combination thereof.

To illustrate, a location of a designated resource within each subblock of resources may initially be indicated by the network node in RRC signaling, and the network node may determine to dynamically adjust one or more attributes of the designated resource based on real-time channel conditions or predefined criteria. For instance, the network node may monitor channel quality indicators, such as signal-to-noise ratio (SNR) or CSI, to determine the optimal positioning of the designated resource within each subblock of resources. Based at least in part on detecting a change in channel quality (e.g., a change that satisfies a threshold), the network node may transmit an adjustment to the location, size, or other attributes of the designated resource (or one or more subblocks of resources) via DCI or higher layer signaling (e.g., MAC-CE or RRC signaling). The ability for the network node to dynamically adjust attribute(s) of the designated resource may enable the network node to configure a location or size of the phase shift indication in a manner that mitigates interference or signal degradation, resulting in increased robustness and reliability of the transmission. For example, if a segment of the transmission that carries the indication of the phase shift (e.g., by occupying the designated resource) experiences selective fading, the network node may relocate the designated resource to a more favorable position with better radio conditions. Accordingly, the ability to dynamically adjust any combination of a starting location, ending location, or size of the designated resource may ensure optimal positioning of the phase shift indication that mitigates interference or signal degradation, resulting in increased robustness and increased reliability of the transmission.

In some cases, the network node may transmit, in Layer 2 signaling (e.g., a MAC-CE) or Layer 3 signaling (e.g., RRC signaling), multiple possible configurations for a PTS configuration. That is, the network node may transmit, in the Layer 2signaling or the Layer 3 signaling, multiple possible configurations that are valid options or valid configurations for a PTS configuration, such as by transmitting a table that includes the multiple possible configurations. At a later point in time, the network node may transmit (e.g., in Layer 1 signaling) a selection indication that selects a particular configuration from the possible configurations, such as by transmitting an indication of an index into the table. As another example, the transmitter may assign a codepoint to a specific data transmission and may include the codepoint (or an indication of the codepoint) in a transmission header to indicate the PTS configuration information to use for processing the data transmission. The transmitter may then transmit the transmission to the receiver. The receiver may read the codepoint to obtain the PTS configuration information, subblock partitioning information, phase shift information, or any combination thereof.

To further illustrate, a network node may initially configure a UE with a PTS configuration through RRC signaling. The PTS configuration may specify that the designated resource for phase shift information is located at a first resource element (RE) of each subblock. Based at least in part on indicating the PTS configuration, the network node may monitor the channel conditions (e.g., by monitoring SNR or CSI as described above), may determine that the first RE is experiencing interference, and may transmit a DCI message to the UE to dynamically adjust the designated resource to the third RE of each subblock to embed the phase shift in a more reliable part of the transmission and to mitigate the interference corrupting the phase shift information.

An RE is an air interface resource unit specified by a communication standard that may be used to carry data or control information within a wireless communication system. As one example, the subblock of resources that are occupied by a phase-shifted transmission portion may be an allocation of one or more REs. In some aspects, one or more of a size or a location of the designated resource within the subblock of resources may be fixed, regulated, or bounded (e.g., limited or constrained) to one or more of a particular size or a particular location that may be specified in terms of REs to ensure that the phase shift information is embedded effectively within a transmission (e.g., data channel transmission). Fixing or regulating a size or location of the designated resource may enable a transmitter to apply the phase shift applied to an entirety of the portion of transmission that occupies each resource in the subblock of resources, enabling a receiver to easily identify and decode the phase shift.

As one example, a communication standard or a network node may designate that a segment of a transmission that occupies one or more designated REs within each subblock of resources have a known phase, resulting in phase shift information that is embedded alongside data (e.g., user data or control information), enhancing overall system efficiency. “Known phase” denotes a predetermined phase shift that is known and coordinated between both a transmitter and a receiver. The use of a known phase may serve as a reference point, enabling a receiver to accurately estimate a phase shift that is applied to an entirety of a transmission portion that occupies the entire subblock of resources based at least in part on the receiver analyzing the designated RE(s).

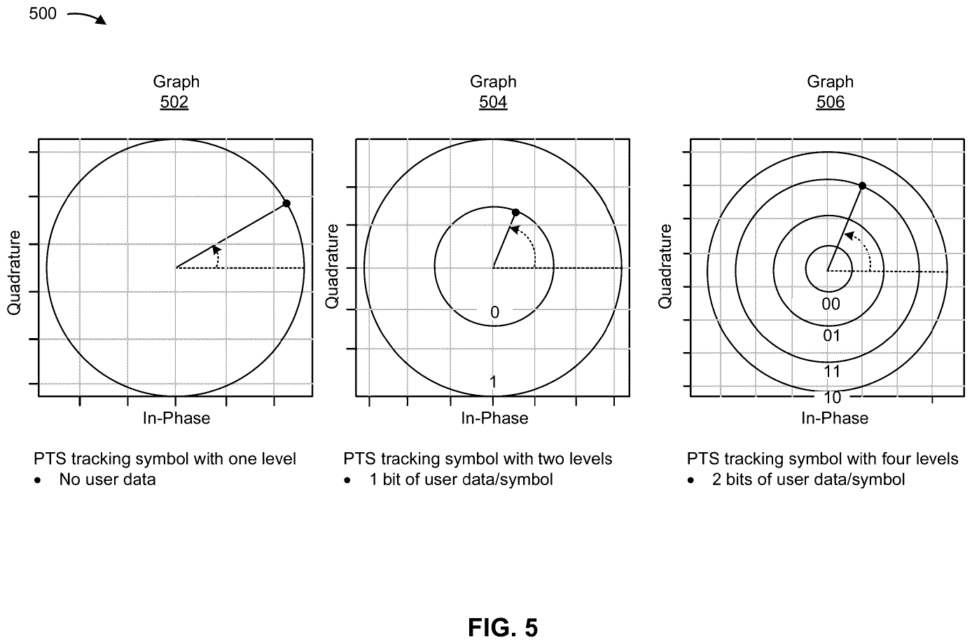

In some aspects, a segment of the transmission that occupies the designated resource (e.g., one or more phase tracking REs) may be amplitude modulated to embed information or data (e.g., user data or control information) to increase system efficiency (e.g., increased data throughput or reduced signaling overhead). For example, an amplitude modulation scheme used by the transmitter may have two distinct amplitude levels, enabling the transmitter to embed one bit of data per RE in the transmission for each RE of the designated resource. As another example, the amplitude modulation scheme used by the transmitter may have four distinct amplitude levels, resulting in the transmitter being able to embed two bits of data per RE in the transmission for each RE of the designated resource. A transmitter may dynamically adjust a quantity or number of amplitude levels used for embedding user data based at least in part on current channel conditions (e.g., identifiable by one or more measurement metrics). The ability to dynamically adjust a number or quantity of amplitude levels and, subsequently, an amount of data that may be transmitted via the designated resource, enables the transmitter to optimize and balance a trade-off between a data embedding capacity and robustness of the transmission. Embedding user data in the segment of the transmission that occupies the designated resource (e.g., the one or more phase tracking REs) may also enable the transmitter to reduce signaling overhead relative to transmitting phase shift information via a separate channel. The use of amplitude modulation for data embedding in the designated resource may also provide flexibility to efficiently enhance data throughput while maintaining the integrity of the phase shift information. As one example, a transmitter may use a 16-QAM modulation scheme (e.g., for symbols within a transmission portion that do not carry an indication of phase shift information) with two amplitude levels to embed user data in a segment of a transmission portion that occupies a designated resource of a subblock of resources. In some aspects, a transmitter may map the phase shift information to a phase component of the signal and the user data to an amplitude component. To illustrate, as described above, the amplitude levels may represent a first binary value (e.g., “0”) and a second binary value (e.g., “1”) respectively, enabling the transmitter to embed one bit of user data per RE within the designated resource. Based at least in part on receiving the transmission, a receiver may decode the phase shift information from the phase component and the user data from the amplitude component, resulting in increased data transfer efficiency or spectral efficiency of the transmission by combining phase shift information and user data in the same REs. Examples of amplitude modulation are described below with regard to FIG. 5.

To generate a PTS-based transmission, and in a similar manner as described with regard to FIG. 3, a transmitter may perform an IFFT on each symbol subblock to convert a frequency domain signal to a time domain. The transmitter may then apply a respective phase shift to each subblock using one or more mixers, and may combine the phase-shifted subblocks to form a final transmission signal. In some aspects, the transmitter may configure the PTS-based transmission in a manner such that each segment of the transmission that occupies the respective designated resource within the respective subblock carries the phase shift indication and, in some cases, user data through amplitude modulation.

Embedding phase shift information directly in a phase-shifted transmission, where a segment of the transmission that carries the phase shift information is also phase-shifted by the indicated phase shift, and utilizing amplitude modulation for data embedding reduces signaling overhead by mitigating the use a separate control channel to transmit phase shift information, resulting in increased spectral efficiency. Embedding phase shift information directly in a phase-shifted transmission may also increase an efficiency of a PA, mitigate high-path-loss, and reduce out-of-band emissions, such as a high path-loss and out-of-band emissions associated with an NTN. The dynamic adjustment of the designated resource based on real-time channel conditions may enable a network node to optimally position a phase shift indication to mitigate interference and signal degradation, resulting in increased robustness and reliability of the transmission.

As indicated above, FIG. 4 is provided as an example. Other examples may differ from what is described with regard to FIG. 4.

FIG. 5 is a diagram illustrating an example 500 of amplitude modulation as applied to a segment of a transmission that carries an indication of a phase shift.

The example 500 shown by FIG. 5 includes a first graph 502, a second graph 504, and a third graph 506, that illustrate respective QAM constellations that may be used to embed data in a segment of a transmission that carries an indication of a phase shift. Each graph corresponds to a different QAM constellation size and demonstrates how a transmitter may use amplitude modulation to encode additional bits of data.

The first graph 502 is an example of a constellation for a transmission that uses one amplitude level. Accordingly, based at least in part on the use of a single amplitude level, a transmitter may not embed user data on the transmission through the use of amplitude modulation. With regard to a designated resource that includes one or more REs, a transmission that occupies the designated resource uses 100% of the RE(s) to indicate phase tracking information.

The second graph 504 is an example of constellation for a transmission that uses two amplitude levels for amplitude modulation, thus enabling a transmitter to indicate one bit of data or information per symbol. For instance, a first amplitude level may indicate a first bit value (e.g., “0”) and a second amplitude level may indicate a second bit value (e.g., “1”).

The third graph 506 is an example of constellation for a transmission that uses four amplitude levels for amplitude modulation, thus enabling a transmitter to embed two bits of data or information per symbol. To illustrate, a first amplitude level may indicate a first combination of bit values (e.g., “00”), a second amplitude level may indicate a second combination of bit values (e.g., “01”), a third amplitude level may indicate a third combination of bit values (e.g., “10”), and a fourth amplitude level may indicate a fourth combination of bit values (e.g., “11”).

In combination, the first graph 502, the second graph 504, and the third graph 506 provide insight into a trade-off between a number or quantity of amplitude levels used by a transmitter for embedding information or data on a segment of a transmission that indicates a phase shift and a spectral efficiency loss due to phase tracking. In some aspects, the amplitude levels in the three graphs may be scaled based at least in part on a degree of PTS phase quantization (e.g., if applicable) to ensure compliance with a nominal transmit power operating condition for each RE. A quantity or number of amplitude levels may not match the QAM constellation sizes shown by FIG. 5. In some aspects, a higher MCS may tolerate a greater number of amplitude levels in balance with bit error rate (BER) performance relative to a lower MCS.

As indicated above, FIG. 5 is provided as an example. Other examples may differ from what is described with regard to FIG. 5.

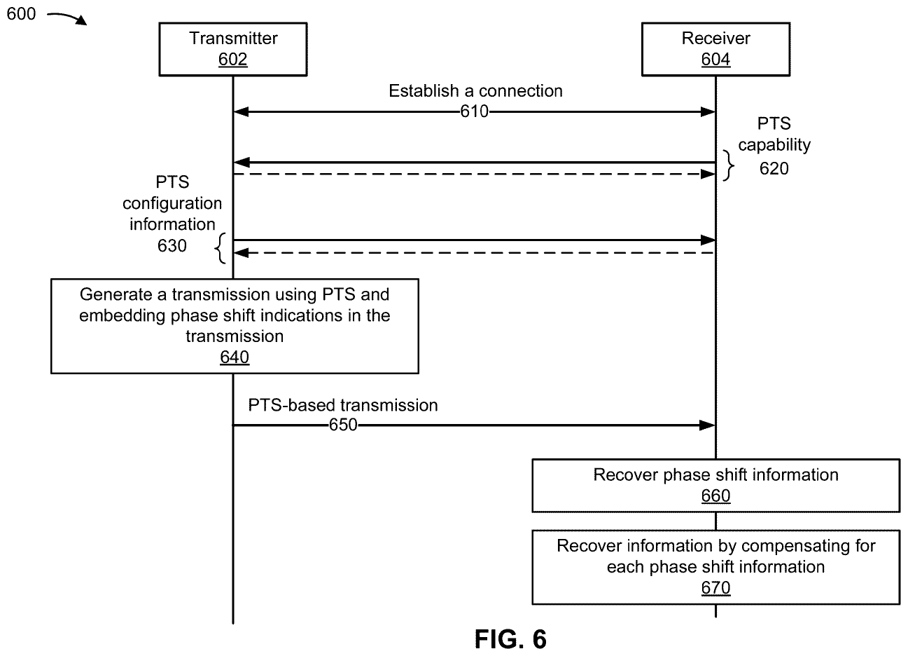

FIG. 6 is a diagram illustrating an example 600 of a wireless communication process between a transmitter 602 (e.g., a network node 110 or a UE 120) and a receiver (e.g., a UE 120 or a network node 110. The transmitter 602 may transmit communications to the receiver 604, receive communications from the receiver 604, or both, and the receiver 604 may transmit communications to the transmitter 602, receive communications from the transmitter 602, or both. In the example 600, the transmitter 602 is a first wireless communication device that generates a PTS-based transmission that embeds phase shift information in designated resources as described with regard to FIG. 4 and FIG. 5, and the receiver is a second wireless communication device that recovers the phase shift information and compensates for the phase shifts as described with regard to FIG. 4. However, the transmitter 602 may also include phase shift recovery and compensation functionality as described with regard to the receiver 604, the receiver 604 may include PTS-based transmission generation functionality described with regarding to the transmitter 602, or both.

As shown by reference number 610, a transmitter 602 and a receiver 604 may establish a connection. For example, the transmitter 602 may be a network node 110 and the receiver 604 may be a UE 120. In some scenarios, the UE 120 may power up in a cell coverage area provided by the network node 110, and the UE 120 and the network node 110 may perform one or more procedures, such as a random access channel (RACH) procedure or an RRC procedure, to establish a wireless connection. The network node 110 and the UE 120 may communicate via the connection based on any combination of Layer 1 signaling (e.g., DCI or UCI), Layer 2 signaling (e.g., a MAC-CE), Layer 3 signaling (e.g., RRC signaling), or any combination thereof. In some aspects, establishing a connection may include establishing a wireless link. For example, the transmitter 602 may be a network node, and the receiver 604 may be a UE. In some scenarios, the UE may initiate a connection procedure within the coverage area of the network node, performing processes such as a RACH procedure or an RRC procedure to set up a wireless connection. The transmitter 602 and the receiver 604 may communicate via the connection using any combination of Layer 1, Layer 2, or Layer 3 signaling methods.

As shown by reference number 620, the receiver 604 may transmit, and the transmitter 602 may receive, an indication of a PTS capability. For instance, the receiver 604 may be a UE 120 that indicates support for PTS-based transmissions that embed phase shift information in designated resources as described with regard to FIG. 4 and FIG. 5. In some aspects, the transmitter 602 may also indicate a PTS capability to the receiver 604 as further emphasized by FIG. 6 through the use of a dashed line from the transmitter 602 to the receiver 604, such as in a scenario in which the transmitter 602 is a UE and the receiver 604 is a network node. Additionally, or alternatively, the receiver 604 may indicate, as at least part of the PTS capability, support for PTS operations. For instance, the receiver 604 may confirm a capability to process PTS-based transmissions that embed phase shift information into specified resources (e.g., a designated resource of a subblock of resources).

As shown by reference number 630, the transmitter 602 may transmit, and the receiver 604 may receive, PTS configuration information. For example, the PTS configuration information may specify a location of the resource(s) that are allocated to the indication of the respective phase shift of each subblock, information about a subblock, or a combination thereof. That is, the PTS configuration may indicate one or more attributes of one or more designated resources, the subblocks in a PTS-based transmission, or a combination thereof, such as a starting location of each subblock, an ending location of each subblock, a size of each subblock, a location of a respective designated resource for phase shift information in each subblock, or a quantity of subblocks in the transmission. Transmitting an indication of the PTS configuration information may include the transmitter 602 transmitting the PTS configuration indication in a broadcast message, a multicast message, or a unicast message. In some aspects, the receiver 604 may transmit, and the transmitter 602 may receive, PTS configuration information as further emphasized by FIG. 6 through the use of a dashed line, such as in a scenario in which the transmitter 602 is a UE and the receiver 604 is a network node.

As shown by reference number 640, the transmitter 602 may generate a transmission using PTS and embedding phase shift indications in the transmission. For example, the transmitter 602 may partition each symbol into multiple subblocks of resources as described with regard to FIG. 3 and FIG. 4, and may embed an indication of a phase shift in a segment of the transmission that occupies the respective resource(s) of each subblock that are designated for an indication of a respective phase shift (e.g., each respective designated resource). In some aspects, the segment of the transmission that occupies the designated resource may be phase-shifted with a same phase shift that is applied to a remaining portion of the transmission and the same phase shift indication that is carried by the segment. Alternatively, or additionally, the transmitter 602 may apply amplitude modulation to the segment as described with regard to FIG. 4 and FIG. 5.

As shown by reference number 650, the transmitter 602 may transmit, and the receiver 604 may receive, a PTS-based transmission. For example, the PTS-based transmission may be the transmission generated by the transmitter 602 as described with regard to reference number 640.

As shown by reference number 660, the receiver 604 may recover phase shift information from the PTS-based transmission. For example, the receiver 604 may estimate a respective phase shift applied to each segment that occupies a respective designated resource of a respective subblock.

As shown by reference number 670, the receiver 604 may recover information from the PTS-based transmission by compensating for each phase shift indicated in the PTS-based transmission. To illustrate, the receiver 604 may generate a modified transmission by removing or adjusting for the respective phase shift applied to each phase-shifted transmission portion. The receiver may process the modified transmission to recover information.

Embedding phase shift information directly in a phase-shifted transmission, where a segment of the transmission that carries the phase shift information is also phase-shifted by the indicated phase shift, and utilizing amplitude modulation for data embedding reduces signaling overhead by mitigating the use of a separate control channel to transmit phase shift information, resulting in increased spectral efficiency. Embedding phase shift information directly in a phase-shifted transmission may also increase an efficiency of a PA and reduce out-of-band emissions. The dynamic adjustment of the designated resource based on real-time channel conditions may enable a network node to optimally position a phase shift indication to mitigate interference and signal degradation, resulting in increased robustness and reliability of the transmission.

As indicated above, FIG. 6 is provided as an example. Other examples may differ from what is described with regard to FIG. 6.

FIG. 7 is a diagram illustrating an example process 700 performed, for example, at a receiver or an apparatus of a receiver. Example process 700 is an example where the apparatus or the receiver (e.g., a UE 120 or a network node 110) performs operations associated with phase shift indication in each subblock of a PTS-based transmission.

As shown in FIG. 7, in some aspects, process 700 may include receiving a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process (block 710). For example, the receiver (e.g., using reception component 902 or communication manager 906, depicted in FIG. 9 based at least in part on being a UE, and using reception component 1002 or communication manager 1006, depicted in FIG. 10 based at least in part on being a network node) may receive a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process, as described above.

As further shown in FIG. 7, in some aspects, process 700 may include decoding the one or more symbols of information based at least in part on compensating, for each subblock of the multiple subblocks, for the respective phase shift that is associated with the subblock of resources (block 720). For example, the receiver (e.g., using communication manager 906, depicted in FIG. 9 based at least in part on being a UE, and using communication manager 1006, depicted in FIG. 10 based at least in part on being a network node) may decode the one or more symbols of information based at least in part on compensating, for each subblock of the multiple subblocks, for the respective phase shift that is associated with the subblock of resources, as described above.

Process 700 may include additional aspects, such as any single aspect or any combination of aspects described below or in connection with one or more other processes described elsewhere herein.

In a first aspect, the respective phase shift is a constant phase shift applied to the respective portion of the transmission that occupies an entirety of resources within the subblock of resources.

In a second aspect, decoding the one or more symbols includes decoding, for each subblock of resources of the multiple subblocks, the respective phase shift from the respective portion of the transmission that occupies the at least one resource that is designated for the indication of the respective phase shift, and compensating for the respective phase shift across each resource in the subblock based at least in part on the respective phase shift being constant for each resource.

In a third aspect, the respective portion of the transmission carries content in the at least one resource based at least in part on amplitude modulation, the content being additional to the indication of the respective phase shift.

In a fourth aspect, receiving the transmission includes receiving the transmission in a data channel.

In a fifth aspect, process 700 includes receiving a PTS configuration indication that specifies a location of the at least one resource that is allocated to the indication of the respective phase shift of each subblock of the multiple subblocks.

In a sixth aspect, receiving the PTS configuration indication includes receiving the PTS configuration indication in downlink control information.

In a seventh aspect, the PTS configuration indication specifies at least one of a starting location of each subblock, an ending location of each subblock, a size of each subblock, or a quantity of subblocks in the transmission.

In an eighth aspect, the PTS configuration indication specifies decoding information for decoding content that is carried by the respective portion of the transmission in the at least one resource based at least in part on amplitude modulation, the decoding information including at least one of a first quantity of bits per amplitude-based symbol, or a second quantity of amplitudes per amplitude-based symbol.

In a ninth aspect, process 700 includes receiving, in Layer 2 or Layer 3 signaling, one or more possible configurations that are valid options for use by the PTS configuration indication, and receiving the PTS configuration indication includes receiving, in Layer 1 signaling, a selection indication that selects a particular configuration from the one or more possible configurations.

In a tenth aspect, the multiple subblocks are based at least in part on at least one of contiguous resource partitioning, or non-contiguous resource partitioning.

In an eleventh aspect, a segment of the portion of the transmission that occupies the at least one resource and carries the indication of the respective phase shift includes the phase shift.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a transmitter or an apparatus of a transmitter. Example process 800 is an example where the apparatus or the transmitter (e.g., a network node 110 or a UE 120) performs operations associated with phase shift indication in each subblock of a PTS-based transmission.

As shown in FIG. 8, in some aspects, process 800 may include generating a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process (block 810). For example, the transmitter (e.g., using transmission component 904 or communication manager 906, depicted in FIG. 9 based at least in part on being a UE, and using transmission component 1004 or communication manager 1006, depicted in FIG. 10 based at least in part on being a network node) may generate a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process, as described above.

As further shown in FIG. 8, in some aspects, process 800 may include transmitting the transmission such that, for each subblock of the multiple subblocks, a respective portion of the transmission that occupies the subblock of resources includes the respective phase shift, the indication of the respective phase shift being carried in the respective portion of the transmission that includes the phase shift (block 820). For example, the transmitter (e.g., using transmission component 904 or communication manager 906, depicted in FIG. 9 based at least in part on being a UE, and using transmission component 1004 or communication manager 1006, depicted in FIG. 10 based at least in part on being a network node) may transmit the transmission such that, for each subblock of the multiple subblocks, a respective portion of the transmission that occupies the subblock of resources includes the respective phase shift, the indication of the respective phase shift being carried in the respective portion of the transmission that includes the phase shift, as described above.

Process 800 may include additional aspects, such as any single aspect or any combination of aspects described below or in connection with one or more other processes described elsewhere herein.

In a first aspect, the respective phase shift is a constant phase shift applied to the respective portion of the transmission that occupies an entirety of resources within the subblock of resources.

In a second aspect, the respective portion of the transmission carries content in the at least one resource based at least in part on amplitude modulation, the content being additional to the indication of the respective phase shift.

In a third aspect, transmitting the transmission includes transmitting the transmission in a data channel.

In a fourth aspect, process 800 includes transmitting a PTS configuration indication that specifies a location of the at least one resource that is designated for the indication of the respective phase shift of each subblock of the multiple subblocks.

In a fifth aspect, transmitting the PTS configuration indication includes transmitting the PTS configuration indication in downlink control information.

In a sixth aspect, the PTS configuration indication specifies at least one of a starting location of each subblock, an ending location of each subblock, a size of each subblock, or a quantity of subblocks in the transmission.

In a seventh aspect, the PTS configuration indication specifies decoding information for decoding content that is carried by the respective portion of the transmission in the at least one resource based at least in part on amplitude modulation, the decoding information including at least one of a first quantity of bits per amplitude-based symbol, or a second quantity of amplitudes per amplitude-based symbol.

In an eighth aspect, process 800 includes transmitting, in Layer 2 or Layer 3 signaling, one or more possible configurations that are valid options for use by the PTS configuration indication, and transmitting the PTS configuration indication includes transmitting, in Layer 1 signaling, a selection indication that selects a particular configuration from the one or more possible configurations.

In a ninth aspect, the multiple subblocks include at least one of contiguous resource partitioning, or non-contiguous resource partitioning.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE (e.g., a UE 120), or a UE (e.g., a UE 120) may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the receiver.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7, process 800 of FIG. 8, or a combination thereof. In some aspects, the apparatus 900 or one or more components shown in FIG. 9 may include one or more components of the receiver described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the receiver described above in connection with FIG. 1, such as a radio, one or more RF chains, one or more transceivers, or one or more modems, each of which may in turn be coupled with one or more antennas of the receiver.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the receiver described above in connection with FIG. 1, such as a radio, one or more RF chains, one or more transceivers, or one or more modems, each of which may in turn be coupled with one or more antennas of the receiver described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

Based at least in part on the UE being a receiver, or a receiver including the UE, the reception component 902 may receive a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process. The communication manager 906 may decode the one or more symbols of information based at least in part on compensating, for each subblock of the multiple subblocks, for the respective phase shift that is associated with the subblock of resources.

The reception component 902 may receive a PTS configuration indication that specifies a location of the at least one resource that is allocated to the indication of the respective phase shift of each subblock of the multiple subblocks. Alternatively, or additionally, the reception component 902 may receive, in Layer 2 or Layer 3 signaling, one or more possible configurations that are valid options for use by the PTS configuration indication.

Based at least in part on the UE being a transmitter or including a transmitter, the communication manager 906 may generate a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process. The transmission component 904 may transmit the transmission such that, for each subblock of the multiple subblocks, a respective portion of the transmission that occupies the subblock of resources includes the respective phase shift, the indication of the respective phase shift being carried in the respective portion of the transmission that includes the phase shift.

The transmission component 904 may transmit a PTS configuration indication that specifies a location of the at least one resource that is designated for the indication of the respective phase shift of each subblock of the multiple subblocks. Alternatively, or additionally, the transmission component 904 may transmit, in Layer 2 or Layer 3 signaling, one or more possible configurations that are valid options for use by the PTS configuration indication.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node (e.g., a network node 110), or a network node (e.g., a network node 110) may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the transmitter.

In some aspects, the apparatus 1000 may be configured to perform one or more operations described herein in connection with FIGS. 3-6. Additionally, or alternatively, the apparatus 1000 may be configured to perform one or more processes described herein, such as process 700 of FIG. 7, process 800 of FIG. 8, or a combination thereof. In some aspects, the apparatus 1000 or one or more components shown in FIG. 10 may include one or more components of the transmitter described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the transmitter described above in connection with FIG. 1, such as a radio, one or more RF chains, one or more transceivers, or one or more modems, each of which may in turn be coupled with one or more antennas of the transmitter.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the transmitter described above in connection with FIG. 1, such as a radio, one or more RF chains, one or more transceivers, or one or more modems, each of which may in turn be coupled with one or more antennas of the transmitter described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

Based at least in part on the network node being a transmitter or including a transmitter, the communication manager 1006 may generate a transmission that carries one or more symbols of information based at least in part on a PTS process, each symbol of the one or more symbols being partitioned into multiple subblocks of resources, each subblock of resources including at least one resource that is designated for an indication of a respective phase shift for the subblock, the respective phase shift based at least in part on the PTS process. The transmission component 1004 may transmit the transmission such that, for each subblock of the multiple subblocks, a respective portion of the transmission that occupies the subblock of resources includes the respective phase shift, the indication of the respective phase shift being carried in the respective portion of the transmission that includes the phase shift.

The transmission component 1004 may transmit a PTS configuration indication that specifies a location of the at least one resource that is designated for the indication of the respective phase shift of each subblock of the multiple subblocks. Alternatively, or additionally, the transmission component 1004 may transmit, in Layer 2 or Layer 3 signaling, one or more possible configurations that are valid options for use by the PTS configuration indication.

Based at least in part on the network node being a receiver, or including a receiver, the reception component 1002 may receive a transmission that carries one or more symbols of information, each symbol of the one or more symbols being partitioned into multiple subblocks of resources based at least in part on a PTS process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process. The communication manager 1006 may decode the one or more symbols of information based at least in part on compensating, for each subblock of the multiple subblocks, for the respective phase shift that is associated with the subblock of resources.

The reception component 1002 may receive a PTS configuration indication that specifies a location of the at least one resource that is allocated to the indication of the respective phase shift of each subblock of the multiple subblocks. Alternatively, or additionally, the reception component 1002 may receive, in Layer 2 or Layer 3 signaling, one or more possible configurations that are valid options for use by the PTS configuration indication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a receiver, comprising: receiving a transmission that carries one or more symbols of information, each symbol of the one or more symbols being partitioned into multiple subblocks of resources based at least in part on a partial transmit sequence (PTS) process, each subblock of resources including at least one resource that is designated for an indication of a respective phase shift for the subblock such that a respective portion of the transmission that occupies the subblock of resources includes the respective phase shift, the indication of the respective phase shift being carried in the respective portion of the transmission that includes the phase shift, the respective phase shift being based at least in part on the PTS process; and decoding the one or more symbols of information based at least in part on compensating, for each subblock of the multiple subblocks, for the respective phase shift that is associated with the subblock of resources.

Aspect 2: The method of Aspect 1, wherein the respective phase shift is a constant phase shift applied to the respective portion of the transmission that occupies an entirety of resources within the subblock of resources.

Aspect 3: The method of any of Aspects 1-2, wherein decoding the one or more symbols comprises: decoding, for each subblock of resources of the multiple subblocks, the respective phase shift from the respective portion of the transmission that occupies the at least one resource that is designated for the indication of the respective phase shift; and compensating for the respective phase shift across each resource in the subblock based at least in part on the respective phase shift being constant for each resource.

Aspect 4: The method of any of Aspects 1-3, wherein the respective portion of the transmission carries content in the at least one resource based at least in part on amplitude modulation, the content being additional to the indication of the respective phase shift.

Aspect 5: The method of any of Aspects 1-4, wherein receiving the transmission comprises: receiving the transmission in a data channel.

Aspect 6: The method of any of Aspects 1-5, comprising: receiving a PTS configuration indication that specifies a location of the at least one resource that is allocated to the indication of the respective phase shift of each subblock of the multiple subblocks.

Aspect 7: The method of Aspect 6, wherein receiving the PTS configuration indication comprises: receiving the PTS configuration indication in downlink control information.

Aspect 8: The method of Aspect 6, wherein the PTS configuration indication specifies at least one of: a starting location of each subblock, an ending location of each subblock, a size of each subblock, or a quantity of subblocks in the transmission.

Aspect 9: The method of Aspect 6, wherein the PTS configuration indication specifies decoding information for decoding content that is carried by the respective portion of the transmission in the at least one resource based at least in part on amplitude modulation, the decoding information comprising at least one of: a first quantity of bits per amplitude-based symbol, or a second quantity of amplitudes per amplitude-based symbol.

Aspect 10: The method of Aspect 6, further comprising: receiving, in Layer 2 or Layer 3 signaling, one or more possible configurations that are valid options for use by the PTS configuration indication, wherein receiving the PTS configuration indication comprises: receiving, in Layer 1 signaling, a selection indication that selects a particular configuration from the one or more possible configurations. wherein receiving the PTS configuration indication comprises: receiving, in Layer 1 signaling, a selection indication that selects a particular configuration from the one or more possible configurations.

Aspect 11: The method of any of Aspects 1-10, wherein the multiple subblocks are based at least in part on at least one of: contiguous resource partitioning, or non-contiguous resource partitioning.

Aspect 12: The method of any of Aspects 1-11, wherein a segment of the portion of the transmission that occupies the at least one resource and carries the indication of the respective phase shift includes the phase shift.

Aspect 13: A method of wireless communication performed by a transmitter, comprising: generating a transmission that carries one or more symbols of information based at least in part on a partial transmit sequence (PTS) process, each symbol of the one or more symbols being partitioned into multiple subblocks of resources, each subblock of resources including at least one resource that is designated for an indication of a respective phase shift for the subblock, the respective phase shift based at least in part on the PTS process; and transmitting the transmission such that, for each subblock of the multiple subblocks, a respective portion of the transmission that occupies the subblock of resources includes the respective phase shift, the indication of the respective phase shift being carried in the respective portion of the transmission that includes the phase shift.

Aspect 14: The method of Aspect 13, wherein the respective phase shift is a constant phase shift applied to the respective portion of the transmission that occupies an entirety of resources within the subblock of resources.

Aspect 15: The method of any of Aspects 13-14, wherein the respective portion of the transmission carries content in the at least one resource based at least in part on amplitude modulation, the content being additional to the indication of the respective phase shift.

Aspect 16: The method of any of Aspects 13-15, wherein transmitting the transmission comprises: transmitting the transmission in a data channel.

Aspect 17: The method of any of Aspects 13-16, comprising: transmitting a PTS configuration indication that specifies a location of the at least one resource that is designated for the indication of the respective phase shift of each subblock of the multiple subblocks.

Aspect 18: The method of Aspect 17, wherein transmitting the PTS configuration indication comprises: transmitting the PTS configuration indication in downlink control information.

Aspect 19: The method of Aspect 17, wherein the PTS configuration indication specifies at least one of: a starting location of each subblock, an ending location of each subblock, a size of each subblock, or a quantity of subblocks in the transmission.

Aspect 20: The method of Aspect 17, wherein the PTS configuration indication specifies decoding information for decoding content that is carried by the respective portion of the transmission in the at least one resource based at least in part on amplitude modulation, the decoding information comprising at least one of: a first quantity of bits per amplitude-based symbol, or a second quantity of amplitudes per amplitude-based symbol.

Aspect 21: The method of Aspect 17, further comprising: transmitting, in Layer 2 or Layer 3 signaling, one or more possible configurations that are valid options for use by the PTS configuration indication, wherein transmitting the PTS configuration indication comprises: transmitting, in Layer 1 signaling, a selection indication that selects a particular configuration from the one or more possible configurations. wherein transmitting the PTS configuration indication comprises: transmitting, in Layer 1 signaling, a selection indication that selects a particular configuration from the one or more possible configurations.

Aspect 22: The method of any of Aspects 13-21, wherein the multiple subblocks comprise at least one of: contiguous resource partitioning, or non-contiguous resource partitioning.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-12.

Aspect 24: An apparatus for wireless communication at a device, the apparatus comprising one or more memories and one or more processors coupled to the one or more memories, the one or more processors configured to cause the device to perform the method of one or more of Aspects 1-12.

Aspect 25: An apparatus for wireless communication, the apparatus comprising at least one means for performing the method of one or more of Aspects 1-12.

Aspect 26: A non-transitory computer-readable medium storing code for wireless communication, the code comprising instructions executable by one or more processors to perform the method of one or more of Aspects 1-12.

Aspect 27: A non-transitory computer-readable medium storing a set of instructions for wireless communication, the set of instructions comprising one or more instructions that, when executed by one or more processors of a device, cause the device to perform the method of one or more of Aspects 1-12.

Aspect 28: A device for wireless communication, the device comprising a processing system that includes one or more processors and one or more memories coupled with the one or more processors, the processing system configured to cause the device to perform the method of one or more of Aspects 1-12.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-12.

Aspect 30: A device comprising a processing system that includes one or more processors and one or more code-storing memories coupled with the one or more processors, the processing system configured to cause the device to perform the method of one or more of Aspects 1-12.

Aspect 31: A device comprising a processing system that includes processor circuitry and code-storing memory circuitry, the processing system configured to cause the device to perform the method of one or more of Aspects 1-12.

Aspect 32: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 13-22.

Aspect 33: An apparatus for wireless communication at a device, the apparatus comprising one or more memories and one or more processors coupled to the one or more memories, the one or more processors configured to cause the device to perform the method of one or more of Aspects 13-22.

Aspect 34: An apparatus for wireless communication, the apparatus comprising at least one means for performing the method of one or more of Aspects 13-22.

Aspect 35: A non-transitory computer-readable medium storing code for wireless communication, the code comprising instructions executable by one or more processors to perform the method of one or more of Aspects 13-22.

Aspect 36: A non-transitory computer-readable medium storing a set of instructions for wireless communication, the set of instructions comprising one or more instructions that, when executed by one or more processors of a device, cause the device to perform the method of one or more of Aspects 13-22.

Aspect 37: A device for wireless communication, the device comprising a processing system that includes one or more processors and one or more memories coupled with the one or more processors, the processing system configured to cause the device to perform the method of one or more of Aspects 13-22.

Aspect 38: An apparatus for wireless communication at a device, the apparatus comprising one or more memories and one or more processors coupled to the one or more memories, the one or more processors individually or collectively configured to cause the device to perform the method of one or more of Aspects 13-22.

Aspect 39: A device comprising a processing system that includes one or more processors and one or more code-storing memories coupled with the one or more processors, the processing system configured to cause the device to perform the method of one or more of Aspects 13-22.

Aspect 40: A device comprising a processing system that includes processor circuitry and code-storing memory circuitry, the processing system configured to cause the device to perform the method of one or more of Aspects 13-22.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a transmitter, comprising:
one or more memories; and
a processing system that is coupled to the one or more memories and includes one or more processors, individually or collectively, being configured to:
generate a transmission that carries one or more symbols of information based at least in part on a partial transmit sequence (PTS) process, each symbol of the one or more symbols being partitioned into multiple subblocks of resources, each subblock of resources including at least one resource that is designated for an indication of a respective phase shift for the subblock, the respective phase shift based at least in part on the PTS process; and
transmit the transmission such that, for each subblock of the multiple subblocks, a respective portion of the transmission that occupies the subblock of resources includes the respective phase shift, the indication of the respective phase shift being carried in the respective portion of the transmission that includes the phase shift.

2. The apparatus of claim 1, wherein the respective phase shift is a constant phase shift applied to the respective portion of the transmission that occupies an entirety of resources within the subblock of resources.

3. The apparatus of claim 1, wherein the respective portion of the transmission carries content in the at least one resource based at least in part on amplitude modulation, the content being additional to the indication of the respective phase shift.

4. The apparatus of claim 1, the processing system, being configured to:
transmit the transmission in a data channel.

5. The apparatus of claim 1, the processing system, being configured to:
transmit a PTS configuration indication that specifies a location of the at least one resource that is designated for the indication of the respective phase shift of each subblock of the multiple subblocks.

6. The apparatus of claim 5, wherein the processing system, to transmit the PTS configuration indication, is configured to:
transmit the PTS configuration indication in downlink control information.

7. The apparatus of claim 5, wherein the PTS configuration indication specifies at least one of:
a starting location of each subblock,
an ending location of each subblock,
a size of each subblock,
a location of a designated resource for phase shift information, or
a quantity of subblocks in the transmission.

8. The apparatus of claim 5, wherein the PTS configuration indication specifies decoding information for decoding content that is carried by the respective portion of the transmission in the at least one resource based at least in part on amplitude modulation, the decoding information comprising at least one of:
a first quantity of bits per amplitude-based symbol, or
a second quantity of amplitudes per amplitude-based symbol.

9. The apparatus of claim 5, the processing system being configured to:
transmit, in Layer 2 or Layer 3 signaling, one or more possible configurations that are valid options for use by the PTS configuration indication,
wherein the processing system, to transmit the PTS configuration indication, is configured to:
transmit, in Layer 1 signaling, a selection indication that selects a particular configuration from the one or more possible configurations.

10. The apparatus of claim 1, wherein the multiple subblocks comprise at least one of:
contiguous resource partitioning, or
non-contiguous resource partitioning.

11. A method of wireless communication performed by a transmitter, comprising:
generating a transmission that carries one or more symbols of information based at least in part on a partial transmit sequence (PTS) process, each symbol of the one or more symbols being partitioned into multiple subblocks of resources, each subblock of resources including at least one resource that is designated for an indication of a respective phase shift for the subblock, the respective phase shift based at least in part on the PTS process; and
transmitting the transmission such that, for each subblock of the multiple subblocks, a respective portion of the transmission that occupies the subblock of resources includes the respective phase shift, the indication of the respective phase shift being carried in the respective portion of the transmission that includes the phase shift.

12. The method of claim 11, wherein the respective phase shift is a constant phase shift applied to the respective portion of the transmission that occupies an entirety of resources within the subblock of resources.

13. The method of claim 11, wherein the respective portion of the transmission carries content in the at least one resource based at least in part on amplitude modulation, the content being additional to the indication of the respective phase shift.

14. The method of claim 11, wherein transmitting the transmission comprises:
transmitting the transmission in a data channel.

15. The method of claim 11, comprising:
transmitting a PTS configuration indication that specifies a location of the at least one resource that is designated for the indication of the respective phase shift of each subblock of the multiple subblocks.

16. The method of claim 15, wherein transmitting the PTS configuration indication comprises:
transmitting the PTS configuration indication in downlink control information.

17. The method of claim 15, wherein the PTS configuration indication specifies at least one of:
a starting location of each subblock,
an ending location of each subblock,
a size of each subblock,
a location of a designated resource for phase shift information, or
a quantity of subblocks in the transmission.

18. The method of claim 15, further comprising:
transmitting, in Layer 2 or Layer 3 signaling, one or more possible configurations that are valid options for use by the PTS configuration indication,
wherein transmitting the PTS configuration indication comprises:
transmitting, in Layer 1 signaling, a selection indication that selects a particular configuration from the one or more possible configurations.

19. A non-transitory computer-readable medium storing a set of instructions for wireless communication, the set of instructions comprising:
one or more instructions that, when executed by one or more processors of a transmitter, cause the transmitter to:
generate a transmission that carries one or more symbols of information based at least in part on a partial transmit sequence (PTS) process, each symbol of the one or more symbols being partitioned into multiple subblocks of resources, each subblock of resources including at least one resource that is designated for an indication of a respective phase shift for the subblock, the respective phase shift based at least in part on the PTS process; and
transmit the transmission such that, for each subblock of the multiple subblocks, a respective portion of the transmission that occupies the subblock of resources includes the respective phase shift, the indication of the respective phase shift being carried in the respective portion of the transmission that includes the phase shift.

20. The non-transitory computer-readable medium of claim 19, wherein the respective phase shift is a constant phase shift applied to the respective portion of the transmission that occupies an entirety of resources within the subblock of resources.
